(19) United States
(12) Patent Application Publication
(10) Pub. No.: US 2025/0037019 A1
(43) Pub. Date: Jan. 30, 2025

(54) SYSTEMS, METHODS, AND MEDIA FOR GENERATING TRAINING SAMPLES

(71) Applicant: Vishal Misra, New York, NY (US)

(72) Inventor: Vishal Misra, New York, NY (US)

(21) Appl. No.: 18/713,966

(22) PCT Filed: Dec. 12, 2022
(86) PCT No.: PCT/US22/52582

§ 371 Date: May 28, 2024

Related U.S. Application Data
(60) Provisional application No. 63/288,266, filed on Dec. 10, 2021.

(51) Int. Cl. G06N 20/00; G06F 16/242

(52) U.S. Cl. CPC G06N 20/00; G06F 16/243

(57) ABSTRACT

Mechanisms for training a machine learning server instance are provided, the mechanisms including: receiving a structured query from a log; finding structured-query, natural-language-query training pairs that have a semantically similar structured query to the received structured query in a training set; training a machine learning instance using the structured-query, natural-language-query training pairs; providing the received structured query to the machine learning instance after being trained; in response to providing the received structured query to the machine learning instance, receiving a natural language query from the machine learning instance; validating the received natural language query; and adding the received structured query and the validated natural language query as a training pair to the training set.

### CROSS-REFERENCE TO RELATED APPLICATIONS

This application claims the benefit of U.S. Provisional Patent Application No. 63/288,266, filed Dec. 10, 2021, which is hereby incorporated by reference herein in its entirety.

This application is related to U.S. Provisional Patent Application No. 63/086,558, filed Oct. 1, 2020, U.S. Provisional Patent Application No. 63/114,689, filed Nov. 17, 2020, U.S. Provisional Patent Application No. 63/131,979, filed Dec. 30, 2020, and International Application No. PCT/US2021/053197, each of which is hereby incorporated by reference herein in its entirety.

### BACKGROUND

As computer technology has advanced in recent years, people have become accustomed to asking computers questions in natural language. For example, a common query to a smart speaker might be “What is the weather today?”.

Machine learning mechanisms can be used to translate natural queries into queries suitable for non-natural-language-query databases. However, generating training samples from such mechanisms can be a time consuming process.

Accordingly, mechanisms for generating training samples for training machine learning mechanisms are desirable.

### SUMMARY

In accordance with some embodiments, systems, methods, and media for generating training samples are provided.

In some embodiments, methods for training a machine learning server instance are provided, the methods comprising: receiving a structured query from a log; finding structured-query, natural-language-query training pairs that have a semantically similar structured query to the received structured query in a training set; training a machine learning instance using the structured-query, natural-language-query training pairs; providing the received structured query to the machine learning instance after being trained; in response to providing the received structured query to the machine learning instance, receiving a natural language query from the machine learning instance; validating the received natural language query; and adding the received structured query and the validated natural language query as a training pair to the training set.

In some of these embodiments, the machine learning instance is an instance of GENERATIVE PRE-TRAINED TRANSFORMER 3 (GPT3).

In some of these embodiments, finding structured-query, natural-language-query training pairs that have a semantically similar structured query to the received structured query can be performed using a machine learning classifier that has been trained to classify pairs of structured queries as being similar or not similar to classify each combination of: each received structured query; and each structured query of each possible training pair.

In some of these embodiments, finding structured-query, natural-language-query training pairs that have a semantically similar structured query to the received structured query can be performed based on a semantic search.

In some embodiments, systems for training a machine learning server instance are provided, the methods comprising: a memory; and at least one hardware processor that is coupled to the memory and that is collectively configured to: receive a structured query from a log; find structured-query, natural-language-query training pairs that have a semantically similar structured query to the received structured query in a training set; train a machine learning instance using the structured-query, natural-language-query training pairs; provide the received structured query to the machine learning instance after being trained; in response to providing the received structured query to the machine learning instance, receive a natural language query from the machine learning instance; validate the received natural language query; and add the received structured query and the validated natural language query as a training pair to the training set.

In some of these embodiments, the machine learning instance is an instance of GENERATIVE PRE-TRAINED TRANSFORMER 3 (GPT3).

In some of these embodiments, finding structured-query, natural-language-query training pairs that have a semantically similar structured query to the received structured query can be performed using a machine learning classifier that has been trained to classify pairs of structured queries as being similar or not similar to classify each combination of: each received structured query; and each structured query of each possible training pair.

In some of these embodiments, finding structured-query, natural-language-query training pairs that have a semantically similar structured query to the received structured query can be performed based on a semantic search.

In some embodiments, non-transitory computer-readable media containing computer executable instructions that, when executed by a processor, cause the processor to perform a method for training a machine learning server instance are provided, the method comprising: receiving a structured query from a log; finding structured-query, natural-language-query training pairs that have a semantically similar structured query to the received structured query in a training set; training a machine learning instance using the structured-query, natural-language-query training pairs; providing the received structured query to the machine learning instance after being trained; in response to providing the received structured query to the machine learning instance, receiving a natural language query from the machine learning instance; validating the received natural language query; and adding the received structured query and the validated natural language query as a training pair to the training set.

In some of these embodiments, the machine learning instance is an instance of GENERATIVE PRE-TRAINED TRANSFORMER 3 (GPT3).

In some of these embodiments, finding structured-query, natural-language-query training pairs that have a semantically similar structured query to the received structured query can be performed using a machine learning classifier that has been trained to classify pairs of structured queries as being similar or not similar to classify each combination of: each received structured query; and each structured query of each possible training pair.

In some of these embodiments, finding structured-query, natural-language-query training pairs that have a semantically similar structured query to the received structured query can be performed based on a semantic search.

### BRIEF DESCRIPTION OF THE DRAWINGS

FIG. 1 is an example block diagram of a system architecture in accordance with some embodiments.

FIG. 2 is an example block diagram of hardware that can be used in certain components in accordance with some embodiments.

FIG. 3 is an example flow diagram of a process for forming and making a database query in response to a natural language query in accordance with some embodiments.

FIG. 4 is an example flow diagram of a process for training a machine learning algorithm in accordance with some embodiments.

FIG. 5 is an example flow diagram of another process for training a machine learning algorithm in accordance with some embodiments.

FIG. 6 is an example flow diagram of a process for receiving a structure response in accordance with some embodiments.

FIG. 7 is an example flow diagram of a process for generating training samples for a machine learning algorithm in accordance with some embodiments.

### DETAILED DESCRIPTION

In accordance with some embodiments, systems, methods, and media for generating training samples are provided.

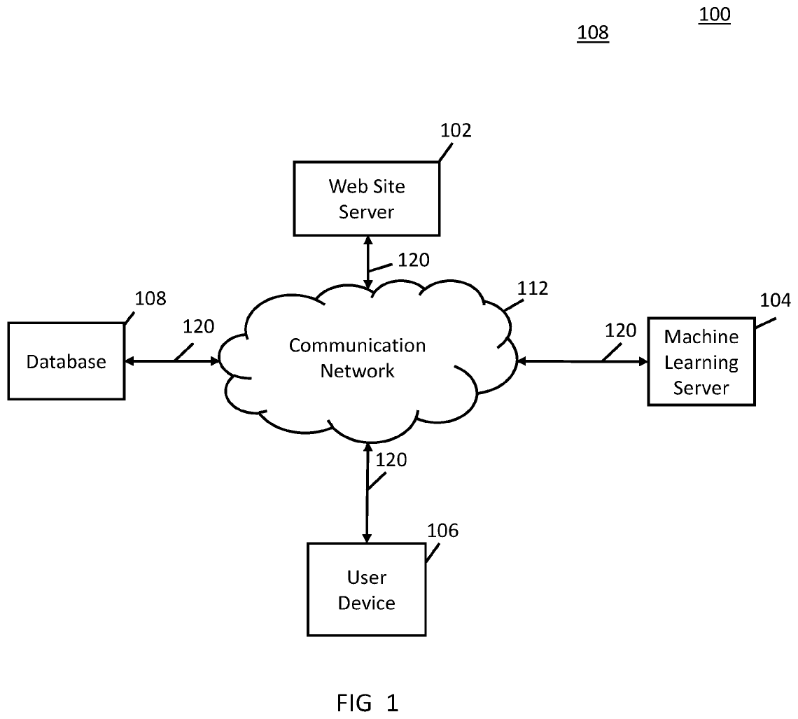

Turning to FIG. 1, an example 100 of hardware that can be used in accordance with some embodiments of the disclosed subject matter is shown. As illustrated, hardware 100 can include a web site server 102, a machine learning server 104, a user device 106, a database 108, and a communication network 112.

Although particular numbers of particular devices are illustrated in FIG. 1, any suitable number(s) of each device shown, and any suitable additional or alternative devices, can be used in some embodiments. For example, one or more additional devices, such as servers, computers, routers, networks, etc., can be included in some embodiments. As another example, in some embodiments, any two or more of devices 102, 104, 106, and 108 can be combined. As yet another example, in some embodiments, device 102 can be omitted and some of the functionality described as being provided thereby can be implemented in user device 106.

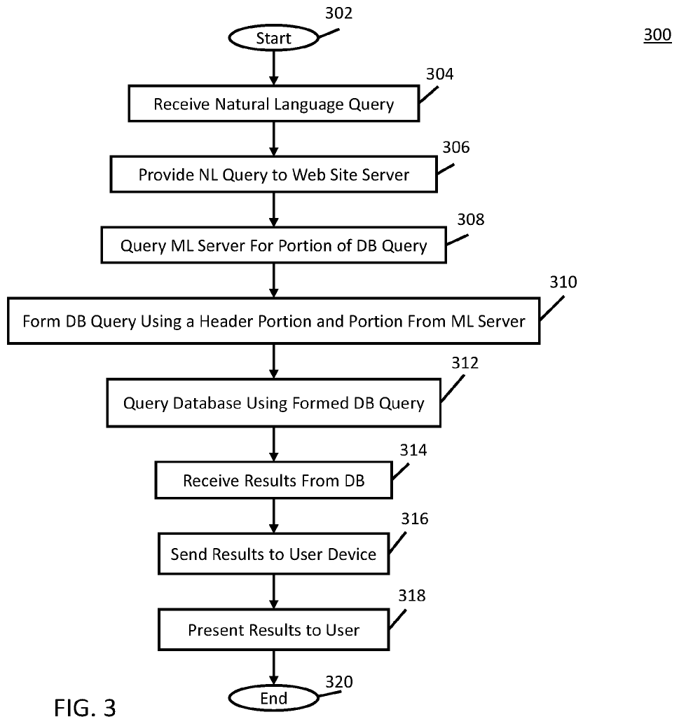

Web site server 102 can be any suitable device for hosting a web site for providing a user interface and performing functions further described below in connection with the process of FIG. 3. In some embodiments, additionally or alternatively to server 102 being a web site server, in some embodiments, server 102 can be a server that interfaces with an app running on a user device 106 and that receives queries, interacts with server 102, displays results responsive to the queries.

Machine learning server 104 can be any suitable server for hosting a machine learning engine or model, and any suitable machine learning technology can be implemented by machine learning server 104, in some embodiments. For example, in some embodiments, machine learning server 104 can implement GPT-3 available from OPEN AI of San Francisco, California.

User device 106 can be any suitable device for receiving a natural language query from a user, providing same to web site server 102, receiving database search results from a database query, and presenting the database search results to the user in some embodiments. For example, in some embodiments, user device 106 can be a smart phone, a laptop computer, a desktop computer, a tablet computer, a smart speaker, a smart display, a smart appliance, a smart watch, a navigation system, and/or any other suitable device capable of receiving a natural language query from a user, providing same to web site server 102, receiving database search results from a database query, and presenting the database search results to the user. The natural language query can be received by the user device as typed text, hand-written text, or spoken words in some embodiments. In some embodiments, user device 106 can run a Web Browser and present web pages. In other embodiments. user device 106 can run an app that interfaces with server 102 to access data via an application programming interface (API).

Database 108 can be any suitable database running on any suitable hardware in some embodiments. For example, database 108 run a MICROSOFT SQL database available from MICROSOFT CORP. of Redmond, Washington.

Communication network 112 can be any suitable combination of one or more wired and/or wireless networks in some embodiments. For example, in some embodiments, communication network 112 can include any one or more of the Internet, a mobile data network, a satellite network, a local area network, a wide area network, a telephone network, a cable television network, a WiFi network, a WiMax network, and/or any other suitable communication network.

Web site server 102, machine learning server 104, user device 106, and database 108 can be connected by one or more communications links 120 to communication network 112. These communications links can be any communications links suitable for communicating data among web site server 102, machine learning server 104, user device 106, database 108, and communication network 112, such as network links, dial-up links, wireless links, hard-wired links, routers, switches, any other suitable communications links, or any suitable combination of such links.

In some embodiments, communication network 112 and the devices connected to it can form or be part of a wide area network (WAN) or a local area network (LAN).

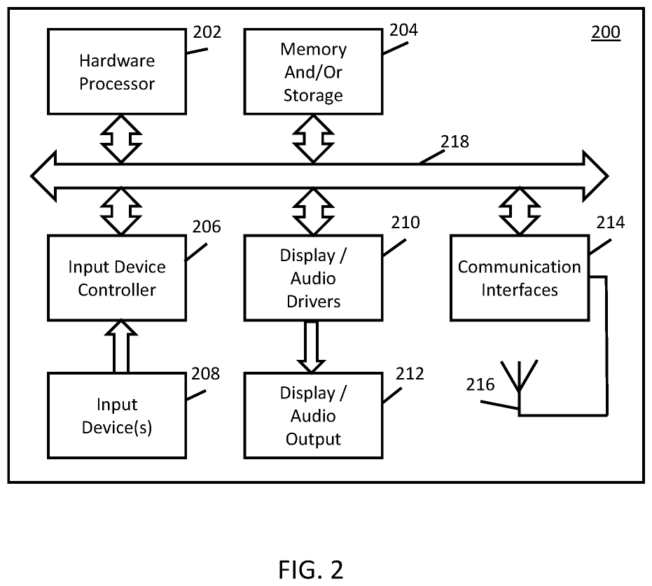

Web site server 102, machine learning server 104, user device 106, and/or database 108 can be implemented using any suitable hardware in some embodiments. For example, in some embodiments, web site server 102, machine learning server 104, user device 106, and/or database 108 can be implemented using any suitable general-purpose computer or special-purpose computer(s). For example, user device 106 can be implemented using a special-purpose computer, such as a smart phone. Any such general-purpose computer or special-purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 204 can be any suitable memory and/or storage for storing programs, data, and/or any other suitable information in some embodiments. For example, memory and/or storage 204 can include random access memory, read-only memory, flash memory, hard disk storage, optical media, and/or any other suitable memory.

Input device controller 206 can be any suitable circuitry for controlling and receiving input from input device(s) 208 in some embodiments. For example, input device controller 206 can be circuitry for receiving input from an input device 208, such as a touch screen, from one or more buttons, from a voice recognition circuit, from a microphone, from a camera, from an optical sensor, from an accelerometer, from a temperature sensor, from a near field sensor, and/or any other type of input device.

Display/audio drivers 210 can be any suitable circuitry for controlling and driving output to one or more display/audio output circuitries 212 in some embodiments. For example, display/audio drivers 210 can be circuitry for driving one or more display/audio output circuitries 212, such as an LCD display, a speaker, an LED, or any other type of output device.

Communication interface(s) 214 can be any suitable circuitry for interfacing with one or more communication networks, such as network 112 as shown in FIG. 1. For example, interface(s) 214 can include network interface card circuitry, wireless communication circuitry, and/or any other suitable type of communication network circuitry.

Antenna 216 can be any suitable one or more antennas for wirelessly communicating with a communication network in some embodiments. In some embodiments, antenna 216 can be omitted when not needed.

Bus 218 can be any suitable mechanism for communicating between two or more components 202, 204, 206, 210, and 214 in some embodiments.

Any other suitable components can additionally or alternatively be included in hardware 200 in accordance with some embodiments.

Turning to FIG. 3, an example 300 of a process in accordance with some embodiments is illustrated. As shown, after process 300 begins at 302, in some embodiment, the process can receive a natural language query at user device 106 at 304 and provide the natural language query to web site server 102 at 306. The web site server can then query machine learning server 104 for a portion of a query to be later submitted to database 108 and receive the portion of the query from machine learning server 104 at 308. Web site server 102 can next form a query for database 108 by combining a header portion for the query with the portion of the query received from machine learning server 104 at 310. The formed query can then be submitted to database 108 by web site server 102 at 312 and the results received at web site server 102 at 314. The results can then be provided by web site server 102 to user device 106 at 316, which can present the results to the user at 318. Finally, process 300 can end at 320.

In some embodiments, a web site on web site server 102 that implements process 300 can be implemented using any suitable code. For example, in some embodiments, a web site that implements process 300 can be implemented using the HTML code shown in Appendix A below and the Python code shown in Appendix B below.

In some embodiments, header portions that can be used to form a database query at 310 can have any suitable form and content. For example, in some embodiments, the headers can be as shown in Table 1. Also shown in the following table are corresponding tags and print column headings. The tags can be used by process 300 to select an appropriate header for a desired query at 310 in some embodiments. The print column heading can be used by process 300 to present database query results to a user at 318 in some embodiments.

TABLE 1
EXAMPLE SQL HEADERS AND PRINTED COLUMN HEADING

| Tag | Header | Print |
|---|---|---|
| Batting | SELECT SQL_CALC_FOUND_ROWS | Mat, Inn, Runs, HS, |
| | ′overall′ AS ‘overall‘, | Batt Ave, 100s, 50s, |
| | COUNT(DISTINCT y.match_id) AS ‘Mat‘, SUM(y.innings) AS ‘Inn‘, | Wkts, Bowl Ave, |
| | IF(SUM(y.innings),1,0) AS ‘chk_batting‘, | bbi, bbm, 5Ws, |
| | SUM(y.runs) AS ‘Runs‘, | caught, stumped |
| | RIGHT(MAX(y.high_score), 4) AS ‘HS‘, | |
| | TRUNCATE(SUM(y.runs)/SUM(y.outs) + 1e−10, 2) AS ‘Batt Ave‘, | |
| | SUM(y.hundreds) AS ‘100s‘, SUM(y.fifty_plus)-SUM(y.hundreds) AS | |
| | ‘50s‘, | |
| | IF(SUM(y.innings_bowled),1,0) AS ‘chk_bowling‘, | |
| | SUM(y.wickets) AS ‘Wkts‘, | |
| | RIGHT(MAX(y.bbi),6) AS ‘bbi‘, RIGHT(MAX(y.bbm),6) AS ‘bbm‘, | |
| | TRUNCATE(SUM(y.conceded)/SUM(y.wickets) + 1e−10, 2) AS | |
| | ‘Bowl Ave‘, | |
| | SUM(y.five_wickets) AS ‘5Ws‘, | |
| | IF(SUM(y.innings_fielded),1,0) AS ‘chk_fielding‘, | |
| | SUM(y.caught) AS ‘caught‘, | |
| | SUM(y.stumped) AS ‘stumped‘, | |
| | TRUNCATE(SUM(y.runs)/SUM(y.outs) - | |
| | SUM(y.conceded)/SUM(y.wickets) + 1e−10, 2) AS ‘allround_average‘, | |
| | 1 AS ‘_orderby1‘ | |
| | FROM eng_match_player x | |
| | INNER JOIN wcms.lookup_records_class_ids xc ON | |
| | x.international_class_id=xc.class_id | |
| | INNER JOIN eng_allround y ON x.id=y.match_player_id | |
| | INNER JOIN wcms.cms_player p ON x.player_id=p.id | |
| | INNER JOIN wcms.rel_team_name t ON x.team_name_id=t.id | |
| | WHERE x.international_valid = ′1′ | |
| Batting_old | SELECT SQL_CALC_FOUND_ROWS | [“matches”, “innings”, |
| | IF(SUM(y.innings),1,0) AS ‘chk_batting‘, | “notouts”, “runs”, |
| | COUNT(DISTINCT y.match_id) AS ‘Mat‘, | “high_score”, |
| | SUM(y.innings) AS ‘Inn‘, | “batting_average”, |
| | SUM(y.notouts) AS ‘NO‘, | “hundreds”, “fifties”, |
| | SUM(y.runs) AS ‘Runs‘, | “ducks”, “strike_rate”] |
| | RIGHT(MAX(y.high_score), 4) AS ‘HS‘, | |
| | TRUNCATE(SUM(y.runs)/SUM(y.outs) + 1e−10, 2) AS ‘AVE‘, | |
| | CONCAT(SUM(y.balls_faced), IF(SUM(y.balls_faced IS NULL), | |
| | ′+′, ″)) AS ‘balls_faced‘, | |
| | CONCAT(TRUNCATE(100*SUM(IF(y.balls_faced IS NULL, 0, | |
| | y.runs))/SUM(y.balls_faced) + 1e−10, 2), IF(SUM(y.balls_faced IS | |
| | NULL), ′*′, ″)) AS ‘SR‘, | |
| | SUM(y.hundreds) AS ‘100s‘, | |
| | SUM(y.fifty_plus)-SUM(y.hundreds) AS ‘50s‘, | |
| | SUM(y.ducks) AS ‘0s‘, | |
| | CONCAT(SUM(y.fours), IF(SUM(y.fours IS NULL), ′+′, ″)) AS | |
| | ‘4s‘, | |
| | CONCAT(SUM(y.sixes), IF(SUM(y.sixes IS NULL), ′+′, ″)) AS | |
| | ‘6s‘, | |
| | 1 AS ‘_orderby1‘, | |
| | IF(SUM(y.innings),1,0) AS ‘_orderby2‘ | |
| | FROM eng_match_player x | |
| | INNER JOIN wcms.lookup_records_class_ids xc ON | |
| | x.international_class_id=xc.class_id | |
| | INNER JOIN eng_batting y ON x.id=y.match_player_id | |
| | WHERE x.international_valid = ′1′ | |
| batting_with_runs | SELECT SQL_CALC_FOUND_ROWS ′filtered′ AS ‘filtered‘, | [“matches”, “innings”, |
| | CONCAT(YEAR(MIN(x.start_date)), ′-′, YEAR(MAX(x.end_date))) AS | “notouts”, “runs”, |
| | ‘span‘, CONCAT(DATE_FORMAT(MIN(x.start_date), ′%e %b | “high_score”, |
| | %Y′),′\t′,DATE_FORMAT(MAX(x.end_date), ′%e %b %Y′)) AS | “batting_average”, |
| | ‘dd_span‘, CONCAT(DATE_FORMAT(MIN(x.start_date), ′%e %b | “hundreds”, “fifties”, |
| | %Y′),′\t′,DATE_FORMAT(MAX(x.end_date), ′%e %b %Y′)) AS | “ducks”, “strike_rate”] |
| | ‘dd_span_desc‘, COUNT(DISTINCT y.match_id) AS ‘matches‘, | |
| | IF(SUM(y.innings),1,0) AS ‘chk_batting‘, SUM(y.runs) AS ‘runs‘, | |
| | RIGHT(MAX(y.high_score), 4) AS ‘high_score‘, | |
| | TRUNCATE(SUM(y.runs)/SUM(y.outs) + 1e−10, 2) AS | |
| | ‘batting_average‘, SUM(y.hundreds) AS ‘hundreds‘, | |
| | IF(SUM(y.innings_bowled),1,0) AS ‘chk_bowling‘, SUM(y.wickets) | |
| | AS ‘wickets‘, RIGHT(MAX(y.bbi),6) AS ‘bbi‘, | |
| | TRUNCATE(SUM(y.conceded)/SUM(y.wickets) + 1e−10, 2) AS | |
| | ‘bowling_average‘, SUM(y.five_wickets) AS ‘five_wickets‘, | |
| | IF(SUM(y.innings_fielded),1,0) AS ‘chk_fielding‘, SUM(y.caught) AS | |
| | ‘caught‘, SUM(y.stumped) AS ‘stumped‘, | |
| | TRUNCATE(SUM(y.runs)/SUM(y.outs) - | |
| | SUM(y.conceded)/SUM(y.wickets) + 1e−10, 2) AS ‘allround_average‘ | |
| | FROM eng_match_player x INNER JOIN | |
| | wcms.lookup_records_class_ids xc ON | |
| | x.international_class_id=xc.class_id INNER JOIN eng_allround y ON | |
| | x.id=y.match_player_id LEFT JOIN eng_batting x1 ON | |
| | y.batting_id=x1.id | |
| Batting Records | SELECT SQL_CALC_FOUND_ROWS | player, matches, |
| | p.name AS ‘player‘, | innings, notouts, |
| | p.id AS ‘dd_player‘, | runs, high_score, |
| | IF(MAX(x.captain),p.id,″) AS ‘dd_captain‘, | batting_average, |
| | p.name AS ‘dd_captain_desc‘, | hundreds, fifties, |
| | x.player_object_id AS ‘dd_player_analysis‘, | ducks |
| | x.player_object_id AS ‘www_player‘, | |
| | GROUP_CONCAT(DISTINCT t.abbreviation ORDER BY | |
| | t.abbreviation ASC SEPARATOR ′/′) AS ‘post_abbreviation_teams‘, | |
| | GROUP_CONCAT(DISTINCT t.team_id ORDER BY t.abbreviation | |
| | ASC SEPARATOR ′\t′) AS ‘dd_team‘, | |
| | GROUP_CONCAT(DISTINCT t.full_name ORDER BY | |
| | t.abbreviation ASC SEPARATOR ′\t′) AS ‘dd_team_desc‘, | |
| | CONCAT(YEAR(MIN(x.start_date)), ′-′, YEAR(MAX(x.end_date))) | |
| | AS ‘span‘, | |
| | CONCAT(DATE_FORMAT(MIN(x.start_date), ′%e %b | |
| | %Y′),′\t′,DATE_FORMAT(MAX(x.end_date), ′%e %b %Y′)) AS | |
| | ‘dd_span‘, | |
| | CONCAT(DATE_FORMAT(MIN(x.start_date), ′%e %b | |
| | %Y′),′\t′,DATE_FORMAT(MAX(x.end_date), ′%e %b %Y′)) AS | |
| | ‘dd_span_desc‘, | |
| | IF(SUM(y.innings),1,0) AS ‘chk_batting‘, | |
| | COUNT(DISTINCT y.match_id) AS ‘matches‘, | |
| | SUM(y.innings) AS ‘innings‘, | |
| | SUM(y.notouts) AS ‘notouts‘, | |
| | SUM(y.runs) AS ‘runs‘, | |
| | RIGHT(MAX(y.high_score), 4) AS ‘high_score‘, | |
| | TRUNCATE(SUM(y.runs)/SUM(y.outs) + 1e−10, 2) AS | |
| | ‘batting_average‘, | |
| | SUM(y.hundreds) AS ‘hundreds‘, | |
| | SUM(y.fifty_plus)-SUM(y.hundreds) AS ‘fifties‘, | |
| | SUM(y.ducks) AS ‘ducks‘, | |
| | IF(SUM(y.innings)=0, −2, IF(SUM(y.outs)=0, SUM(y.runs), | |
| | TRUNCATE(SUM(y.runs)/SUM(y.outs), 10))) AS ‘_orderby1‘, | |
| | IF(SUM(y.innings),1,0) AS ‘_orderby2‘, | |
| | p.alpha_name AS ‘_orderby3‘ | |
| | FROM eng_match_player x | |
| | INNER JOIN wcms.lookup_records_class_ids xc ON | |
| | x.international_class_id=xc.class_id | |
| | INNER JOIN eng_batting y ON x.id=y.match_player_id | |
| | INNER JOIN wcms.rel_player_style psbas ON | |
| | x.player_id=psbas.player_id AND psbas.category_id=8 | |
| | INNER JOIN wcms.cms_player p ON x.player_id=p.id | |
| | INNER JOIN wcms.rel_team_name t ON x.team_name_id=t.id | |
| | WHERE x.international_valid = ′1′ | |

In accordance with some embodiments, a machine learning engine or model on machine learning server 104 can be trained in any suitable manner. For example, in some embodiments, the machine learning engine or model can be trained using the example training items shown in the Table 2. Any suitable number of training items can be used in some embodiments. As illustrated, these items can each include an example natural language question, a portion of a database query, and a tag in some embodiments. The natural language question can be any suitable natural language question in some embodiments. In the examples below, each natural language question relates to the sport cricket, though the queries are not limited to such content. The portion of the database query can be any suitable portion of a database query that, when combined with a header, e.g., at 310, can form a suitable database query corresponding to the natural language question in some embodiments. The tag can be used to identify a type of natural language question and can be used to associate a question and a database query portion with a header in some embodiments.

TABLE 2
EXAMPLE TRAINING ITEMS:

| Question | SQL | Tag |
|---|---|---|
| What is | AND x.ground_id IN (SELECT id FROM | Batting |
| Jayawardene's | wcms.cms_ground cp where full_name like | |
| record at the Oval | ′%Oval%′) | |
| in England?\n | AND x.international valid = ′1′ | |
| | AND x.player_id IN (SELECT id FROM | |
| | wcms.cms_player cp where known_as like | |
| | ′%Jayewardene%′) AND x.country_id IN | |
| | (SELECT id FROM wcms.cms_team cp where | |
| | short_name like ′%England%′) | |
| What is Kohli's | AND x.ground_id IN (SELECT id FROM | Batting |
| record at the Oval | wcms.cms_ground cp where full_name like | |
| against England?\n | ′%Oval%′) | |
| | AND x.player_id IN (SELECT id FROM | |
| | wcms.cms_player cp where known_as like | |
| | ′%Kohli%′) AND x.opposition_id IN (SELECT | |
| | id FROM wcms.cms_team cp where short_name | |
| | like ′%England%′) | |
| What is Sachin | AND x.player_id IN (SELECT id FROM | Batting |
| Tendulkar's average | wcms.cms_player cp where known_as like | |
| in games that | ′%Sachin Tendulkar%′) AND x.result = ′4′ | |
| were drawn?\n | | |
| What is Sachin | AND x.player_id IN (SELECT id FROM | Batting |
| Tendulkar's fourth | wcms.cms_player cp where known_as like | |
| innings average | ′%Sachin Tendulkar%′) AND x.opposition_id IN | |
| against Sri Lanka in | (SELECT id FROM wcms.cms_team cp where | |
| matches they lost?\n | short_name like ′%Sri Lanka%′) AND | |
| | y.innings_number IN (′4′) AND x.result = ′2′ | |
| What is the batting | AND x.opposition_id IN (SELECT id FROM | Batting |
| record in of Kohli | wcms.cms_team cp where short_name like | |
| against Australia in | ′%Australia%′) | |
| games that India won? | AND x.player_id IN (SELECT id FROM | |
| | wcms.cms_player cp where known_as like ′%Virat | |
| | Kohli%′) | |
| | AND x.result = ′1′ | |
| What is the average | AND x.player_id IN (SELECT id FROM | Batting |
| of Dravid in the | wcms.cms_player cp where known_as like | |
| 4th innings?\n | ′%Dravid%′) AND y.innings_number IN (′4′) | |
| What is the record | AND x.opposition_id IN (SELECT id FROM | Batting |
| of Sunil Gavaskar | wcms.cms_team cp where short_name like | |
| in games against | ′%Pakistan%′) | |
| Pakistan that | AND x.player_id IN (SELECT id FROM | |
| they lost?\n | wcms.cms_player cp where known_as like | |
| | ′%Sunil Gavaskar%′) | |
| | AND x.result = ′2″ | |
| What is the bowling | AND x.player_id IN (SELECT id FROM | Batting |
| record in matches | wcms.cms_player cp where known_as like | |
| of Shane Warne | ′%Shane Warne%′) | |
| that they won?\n | AND x.result = ′1′ | |
| What is the record | AND x.opposition_id IN (SELECT id FROM | Batting |
| of Ashwin against | wcms.cms_team cp where short_name like | |
| West Indies?\n | ′%West Indies%′) AND x.player_id IN | |
| | (SELECT id FROM wcms.cms_player cp where | |
| | known_as like ′%Ashwin%′) | |
| What is the record | AND x.country_id IN (SELECT id FROM | Batting |
| of Ashwin in | wcms.cms_team cp where short_name like | |
| West Indies?\n | ′%West Indies%′) AND x.player_id IN | |
| | (SELECT id FROM wcms.cms_player cp where | |
| | known_as like ′%Ashwin%′) | |
| What is the record | AND x.player_id IN (SELECT id FROM | Batting |
| of Dhoni chasing | wcms.cms_player cp where known_as like | |
| in ODIS games | ′%Dhoni%′) AND x.result = ′1′ AND | |
| they won?\n | y.innings_number IN (′2′) | |
| What is the record | AND x.player_id IN (SELECT id FROM | Batting |
| of Jos Buttler at | wcms.cms_player cp where known_as like ′%Jos | |
| Wankhede?\n | Buttler%′) AND x.ground_id IN (SELECT id | |
| | FROM wcms.cms_ground cp where full_name | |
| | like ′%Wankhede%′) | |
| What is the average | AND x.player_id IN (SELECT id FROM | Batting |
| of KL Rahul?\n | wcms.cms_player cp where known_as like ′%KL | |
| | Rahul%′) | |
| What is the average | AND x.player_id IN (SELECT id FROM | Batting |
| of Stuart Broad | wcms.cms_player cp where known_as like | |
| at home?\n | ′%Stuart Broad%′) AND x.country_id IN | |
| | (SELECT id FROM wcms.cms_team cp where | |
| | short_name like ′%England%′) | |
| What is the record of | AND x.player_id IN (SELECT id FROM | Batting |
| Sourav Ganguly?\n | wcms.cms_player cp where known_as like | |
| | ′%Sourav Ganguly%′) | |
| What is the record | AND x.player_id IN (SELECT id FROM | Batting |
| of Kohli chasing | wcms.cms_player cp where known_as like ′%Virat | |
| in games that had | Kohli%′) AND x.result = ′3′ AND | |
| no result?\n | y.innings_number IN (′2′) | |
| What is the record of | AND x.player_id IN (SELECT id FROM | Batting |
| Rohit Sharma away | wcms.cms_player cp where known_as like | |
| from home?\n | ′%Rohit Sharma%′) and x.country_id NOT IN | |
| | (SELECT id FROM wcms.cms_team cp where | |
| | short_name like ′%India%′) | |
| What is the record | AND x.opposition_id IN (SELECT id FROM | Batting |
| of Rohit Sharma | wcms.cms_team cp where short_name like | |
| against Pakistan in | ′%Pakistan%′) AND x.player_id IN (SELECT id | |
| Australia?\n | FROM wcms.cms_player cp where known_as like | |
| | ′%Rohit Sharma%′) and x.country_id IN | |
| | (SELECT id FROM wcms.cms_team cp where | |
| | short_name like ′%Australia%′) | |
| Who are the top | AND psbas.style_id = ′2′ | Batting Records |
| 5 left handed test | AND x.opposition_id IN (SELECT id FROM | |
| batsmen in a | wcms.cms_team cp where short_name like | |
| draw against the | ′%West Indies%′) | |
| west indies after | AND x.result = ′4′ | |
| losing the toss | AND x.toss = ′2′ | |
| | AND xc.records_class_id = ′1′ | |
| | GROUP BY x.player_id | |
| | ORDER BY ‘_orderby1‘ DESC, ‘_orderby2‘ | |
| | DESC, ‘_orderby3‘ ASC | |
| | LIMIT 5 | |
| Who are the top | AND x.opposition_id IN (SELECT id FROM | Batting Records |
| 10 test batsmen | wcms.cms_team cp where short_name like | |
| in a draw against | ′%Australia%′) | |
| Australia after | AND x.result = ′4′ | |
| winning the toss | AND x.toss = ′1′ | |
| | GROUP BY x.player_id | |
| | ORDER BY ‘_orderby1‘ DESC, ‘_orderby2‘ | |
| | DESC, ‘_orderby3‘ ASC | |
| | LIMIT 10 | |
| Who has scored the | AND x.country_id IN (SELECT id FROM | Batting Records |
| most runs batting in | wcms.cms_team cp where short_name like | |
| the 4th innings of a | ′%India%′) | |
| match they won | AND x.result = ′1′ | |
| after losing the | AND x.toss = ′2′ | |
| toss in India | AND y.innings_number = ′4′ | |
| | GROUP BY x.player_id | |
| | ORDER BY ‘_orderby1‘ DESC, ‘_orderby2‘ | |
| | DESC, ‘_orderby3‘ ASC | |
| Who are the top 10 | AND x.batting_fielding_first = ′1′ | Batting Records |
| openers by runs | AND x.toss = ′2′ | |
| scored in matches | AND (y.batting_position BETWEEN ′1′ AND ′2′) | |
| when they lost the | GROUP BY x.player_id | |
| toss and batted first? | ORDER BY ‘runs‘ DESC, ‘_orderby1‘ DESC, | |
| | ‘_orderby2‘ DESC, ‘_orderby3‘ ASC | |
| | LIMIT 10 | |
| Who are the top | AND y.batting_position = ′5′. AND x.team_id IN | Batting Records |
| 10 test batsmen | (SELECT id FROM wcms.cms_team cp where | |
| at number 5 | short_name like ′%India%′) | |
| from India? | GROUP BY x.player_id | |
| | ORDER BY ‘_orderby1‘ DESC, ‘_orderby2‘ | |
| | DESC, ‘_orderby3‘ ASC | |
| | LIMIT 10 | |
| Who are the top 10 | AND x.country_id IN (SELECT id FROM | Batting Records |
| test batsmen from | wcms.cms_team cp where short_name like | |
| England in India | ′%India%′) AND x.team_id IN (SELECT id | |
| | FROM wcms.cms_team cp where short_name like | |
| | ′%England%′) | |
| | GROUP BY x.player_id | |
| | ORDER BY ‘_orderby1‘ DESC, ‘_orderby2‘ | |
| | DESC, ‘_orderby3‘ ASC | |
| | LIMIT 10 | |
| Who are the top | AND x.country_id IN (SELECT id FROM | Batting Records |
| 5 left handers in | wcms.cms_team cp where short_name like | |
| test matches in | ′%Australia%′) AND psbas.style_id = ′2′ | |
| Australia? | GROUP BY x.player_id | |
| | ORDER BY ‘runs‘ DESC, ‘_orderby1‘ DESC, | |
| | ‘_orderby2‘ DESC, ‘_orderby3‘ ASC | |
| | LIMIT 5 | |
| Who are the top 5 | AND x.country_id IN (SELECT id FROM | Batting Records |
| right handers from | wcms.cms_team cp where short_name like | |
| West Indies batting | ′%India%′) AND psbas.style_id = ′1′ AND | |
| at number 3 in | y.batting_position = ′3′ AND x.team_id IN | |
| India? | (SELECT id FROM wcms.cms_team cp where | |
| | short_name like ′%West Indies%′) | |
| | GROUP BY x.player_id | |
| | ORDER BY ‘runs‘ DESC, ‘_orderby1‘ DESC, | |
| | ‘_orderby2‘ DESC, ‘_orderby3‘ ASC | |
| | LIMIT 5 | |
| Who are the top | ANDAND x.ground_id IN (SELECT id FROM | Batting Records |
| 5 batsmen from | wcms.cms_ground cp where full_name like | |
| Australia at | ′%Headingley%′) AND x.team_id IN (SELECT id | |
| Headingley | FROM wcms.cms_team cp where short_name like | |
| by runs? | ′%Australia%′) | |
| | GROUP BY x.player_id | |
| | ORDER BY ‘runs‘ DESC, ‘_orderby1‘ DESC, | |
| | ‘_orderby2‘ DESC, ‘_orderby3‘ ASC | |
| | LIMIT 5 | |
| Who are the top 10 | AND psbas.style_id = ′2′ | Batting Records |
| left handed openers? | AND (y.batting_position BETWEEN ′1′ AND ′2′) | |
| | GROUP BY x.player_id | |
| | ORDER BY ‘_orderby1‘ DESC, ‘_orderby2‘ | |
| | DESC, ‘_orderby3‘ ASC | |
| | LIMIT 10 | |
| Who are the top | AND y.batting_position = ′8′ AND x.team_id IN | Batting Records |
| scorers batting at | (SELECT id FROM wcms.cms_team cp where | |
| number 8 from | short_name like ′%Sri Lanka%′) | |
| Sri Lanka? | GROUP BY x.player_id | |
| | ORDER BY ‘runs‘ DESC, ‘_orderby1‘ DESC, | |
| | ‘_orderby2‘ DESC, ‘_orderby3‘ ASC | |
| | LIMIT 5 | |
| Who are the top 10 | AND psbas.style_id = ′2′ | Batting Records |
| left handed openers | AND (y.batting_position BETWEEN ′1′ AND ′2′) | |
| by batting averages? | GROUP BY x.player_id | |
| | ORDER BY ‘batting_average‘, ‘_orderby1‘ | |
| | DESC, ‘_orderby2‘ DESC, ‘_orderby3‘ ASC | |
| | LIMIT 10 | |
| Who are the top | AND x.opposition_id IN (SELECT id FROM | Batting Records |
| 10 batsmen in a | wcms.cms_team cp where short_name like | |
| loss against India | ′%India%′) AND x.ground_id IN (SELECT id | |
| at Wankhede after | FROM wcms.cms_ground cp where full_name | |
| winning the toss | like ′%Wankhede%′) | |
| | AND x.result = ′2′ | |
| | AND x.toss = ′1′ | |
| | GROUP BY x.player_id | |
| | ORDER BY ‘_orderby1‘ DESC, ‘_orderby2‘ | |
| | DESC, ‘_orderby3‘ ASC | |
| | LIMIT 10 | |
| Who are the top | AND psbas.style_id = ′2′ | Batting Records |
| 10 right handed | AND y.batting_position = ′5′ | |
| batsmen batting | GROUP BY x.player_id | |
| at number 5? | ORDER BY ‘_orderby1‘ DESC, ‘_orderby2‘ | |
| | DESC, ‘_orderby3‘ ASC | |
| | LIMIT 10 | |
| Who are the top | AND x.ground_id IN (SELECT id FROM | Batting Records |
| 3 batsmen from | wcms.cms_ground cp where full_name like | |
| at the Lord\'s | ′%Lord\‘s%′) | |
| cricket ground | GROUP BY x.player_id | |
| | ORDER BY ‘_orderby1‘ DESC, ‘_orderby2‘ | |
| | DESC, ‘_orderby3‘ ASC | |
| | LIMIT 3 | |
| Who are the top 10 | AND x.batting_fielding_first = ′1′ | batting_records_odi |
| openers by runs | AND x.toss = ′2′ | |
| scored when they | AND (y.batting_position BETWEEN ′1′ AND ′2′) | |
| lost the toss and | GROUP BY x.player_id | |
| batted first in One | ORDER BY ‘runs‘ DESC, ‘_orderby1‘ DESC, | |
| Day Internationals? | ‘_orderby2‘ DESC, ‘_orderby3‘ ASC | |
| | LIMIT 10 | |
| Who are the top | AND x.team_id IN (SELECT id FROM | batting_records_odi |
| scorers from | wcms.cms_team cp where short_name like | |
| South Africa? | ′%South Africa%′) | |
| | GROUP BY x.player_id | |
| | ORDER BY ‘runs‘ DESC, ‘_orderby1‘ DESC, | |
| | ‘_orderby2‘ DESC, ‘_orderby3‘ ASC | |
| | LIMIT 5 | |
| Who are the top | AND xc.records_class_id = ′2′ AND | batting_records_odi |
| scorers at number | y.batting_position = ′8′ AND x.ground_id IN | |
| 8 at Sydney? | (SELECT id FROM wcms.cms_ground cp where | |
| | full_name like ′%Sydney%′) | |
| | GROUP BY x.player_id | |
| | ORDER BY ‘runs‘ DESC, ‘_orderby1‘ DESC, | |
| | ‘_orderby2‘ DESC, ‘_orderby3‘ ASC | |
| | LIMIT 5 | |
| What is the batting | AND x.opposition_id IN (SELECT id FROM | batting_with_runs |
| record in ODIs of | wcms.cms_team cp where short_name like | |
| Kohli against | ′%Australia%′) AND x1.runs >= 40 | |
| Australia that they | AND x.player_id IN (SELECT id FROM | |
| won and he scored | wcms.cms_player cp where known_as like ′%Virat | |
| more than 40?\n | Kohli%′) | |
| | AND x.result = ′1′ | |
| | AND xc.records_class_id = ′2′ | |
| What is the record | AND x.opposition_id IN (SELECT id FROM | batting_with_runs |
| of Ashwin in ODIs | wcms.cms_team cp where short_name like | |
| against West Indies | ′%West Indies%′) AND x.player_id IN | |
| when he scored | (SELECT id FROM wcms.cms_player cp where | |
| more than 20?\n | known_as like ′%Ashwin%′) AND x1.runs >= | |
| | 20 AND xc.records_class_id = ′2′ | |
| What is the record of | AND x.player_id IN (SELECT id FROM | batting_with_runs |
| Dhawan in One Day | wcms.cms_player cp where known_as like | |
| Internationals in | ′%Dhawan%′) AND xc.records_class_id = ′2′ | |
| India when he scored | AND x.country_id IN (SELECT id FROM | |
| less than 50?\n | wcms.cms_team cp where short_name like | |
| | ′%India%′) and x1.runs < 50 | |
| What is the record | AND x.player_id IN (SELECT id FROM | batting_with_runs |
| of Shastri in test | wcms.cms_player cp where known_as like | |
| matches when he | ′%Shastri%′) AND x1.runs >= 50 AND | |
| scored more than | xc.records_class_id = ′1′ | |
| 50?\n | | |
| which left hander has | WHERE x.international_valid = ′1′ | batting_with_runs |
| scored most runs | AND xc.records_class_id = ′2′ AND | |
| batting at number | psbas.style_id = ′2′ | |
| 3 in ODIs? | AND y.batting_position = ′3′ | |
| | GROUP BY x.player_id | |
| | ORDER BY ‘runs‘ DESC, ‘_orderby1‘ DESC, | |
| | ‘_orderby2‘ DESC, ‘_orderby3‘ ASC | |
| | LIMIT 5 | |

Example natural language questions, corresponding machine learning server outputs, and corresponding full database queries that could be produced in accordance with some embodiments are shown below:

### Example 1

The query is: What is Sachin Tendulkar's top score?
The machine learning server output: AND x.player_id IN (SELECT id FROM wcms.cms_player cp where known_as like ‘% Sachin Tendulkar %’)
The full database query:
SELECT SQL_CALC_FOUND_ROWS
   ‘overall’ AS ‘overall’,
   COUNT(DISTINCT y.match_id) AS ‘Mat’, SUM(y.innings) AS ‘Inn’,
   IF(SUM(y.innings), 1,0) AS ‘chk_batting’,
   SUM(y.runs) AS ‘Runs’,
   RIGHT(MAX(y.high_score), 4) AS ‘HS’,
   TRUNCATE(SUM(y.runs)/SUM(y.outs)+1e-10, 2) AS ‘Batt Ave’,
   SUM(y.hundreds) AS ‘100s’, SUM(y.fifty_plus)−SUM(y.hundreds) AS ‘50s’,
   IF(SUM(y.innings_bowled), 1,0) AS ‘chk_bowling’,
   SUM(y.wickets) AS ‘Wkts’,
   RIGHT(MAX(y.bbi),6) AS ‘bbi’, RIGHT(MAX(y.bbm),6) AS ‘bbm’,
   TRUNCATE(SUM(y.conceded)/SUM(y.wickets)+1e-10, 2) AS ‘Bowl Ave’,
   SUM(y.five_wickets) AS ‘5Ws’,
   IF(SUM(y.innings_fielded), 1,0) AS ‘chk_fielding’,
   SUM(y.caught) AS ‘caught’,
   SUM(y.stumped) AS ‘stumped’,
   TRUNCATE(SUM(y.runs)/SUM(y.outs)−SUM(y.conceded)/SUM(y.wickets)+1e-10, 2) AS ‘allround_average’,
   1 AS ‘_orderby 1’
   FROM eng_match_player x
INNER JOIN wcms.lookup_records_class_ids xc ON
x.international_class_id=xc.class_id
   INNER JOIN eng_allround y ON x.id=y.match_player_id
   INNER JOIN wcms.cms_player p ON x.player_id=p.id
   INNER JOIN wcms.rel_team_name t ON x.team_name_id=t.id WHERE
x.international_valid=‘1’ AND xc.records_class_id=1 AND x.player_id IN (SELECT id FROM wcms.cms_player cp where known_as like ‘% Sachin Tendulkar %’)

### Example 2

The query is: What is Rahul Dravid's average in Tests that India won in India?
The machine learning server output: AND x.player_id IN (SELECT id FROM wcms.cms_player cp where known_as like ‘% Rahul Dravid %’) AND x.country_id IN (SELECT id FROM wcms.cms_team cp where short_name like ‘% India %’) AND x.result=‘1’
The full database query:
SELECT SQL_CALC_FOUND_ROWS
   ‘overall’ AS ‘overall’,
   COUNT (DISTINCT y.match_id) AS ‘Mat’, SUM(y.innings) AS ‘Inn’,
   IF(SUM(y.innings), 1,0) AS ‘chk_batting’,
   SUM(y.runs) AS ‘Runs’,
   RIGHT(MAX(y.high_score), 4) AS ‘HS’,
   TRUNCATE(SUM(y.runs)/SUM(y.outs)+1e-10, 2) AS ‘Batt Ave’,
   SUM(y.hundreds) AS ‘100s’, SUM(y.fifty_plus)−SUM(y.hundreds) AS ‘50s’,
   IF(SUM(y.innings_bowled), 1,0) AS ‘chk_bowling’,
   SUM(y.wickets) AS ‘Wkts’,
   RIGHT(MAX(y.bbi),6) AS ‘bbi’, RIGHT(MAX(y.bbm), 6) AS ‘bbm’,
   TRUNCATE(SUM(y.conceded)/SUM(y.wickets)+1e-10, 2) AS ‘Bowl Ave’,
   SUM(y.five_wickets) AS ‘5Ws’,
   IF(SUM(y.innings_fielded), 1,0) AS ‘chk_fielding’,
   SUM(y.caught) AS ‘caught’,
   SUM(y.stumped) AS ‘stumped’,
   TRUNCATE(SUM(y.runs)/SUM(y.outs)−SUM(y.conceded)/SUM(y.wickets)+1e-10, 2) AS ‘allround_average’,
   1 AS ‘_orderby1’
FROM eng_match_player x
INNER JOIN wcms.lookup_records_class_ids xc ON
x.international_class_id=xc.class_id
   INNER JOIN eng_allround y ON x.id=y.match_player_id
   INNER JOIN wcms.cms_player p ON x.player_id=p.id
   INNER JOIN wcms.rel_team_name t ON x.team_name_id=t.id WHERE
x.international valid=‘1’ AND xc.records_class_id=1 AND x.player_id IN (SELECT id FROM wcms.cms_player cp where known_as like ‘% Rahul Dravid %’) AND
x.country_id IN (SELECT id FROM wcms.cms_team cp where short_name like ‘% India %’) AND x.result=‘1’

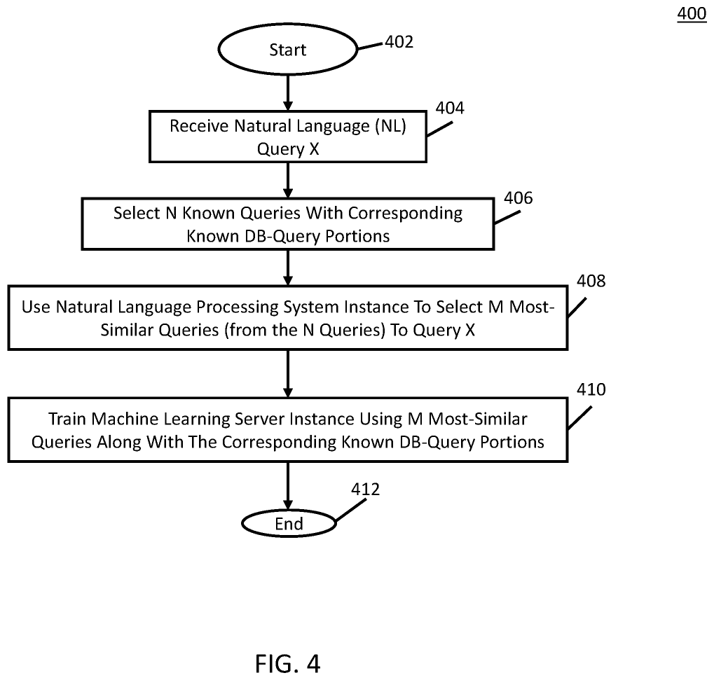

Turning to FIG. 4, an example of a process 400 for training a machine learning algorithm (such as the machine learning algorithm described in connection with process 300 of FIG. 3) to answer a natural language query in accordance with some embodiments is shown. In some embodiments, this machine learning algorithm can run on any suitable machine learning server, such as machine learning server 104 of FIG. 1.

As illustrated, after process 400 begins at 402, the process receives a natural language (NL) query X at 404. In some embodiments, query X can be received at a user device 106 and can be the same natural language query that is received at 304 of FIG. 3.

Next, at 406, process 400 can select N known NL queries with corresponding known database-query portions, wherein the portions are the same as, or similar to, the database-query portions discussed above in 308 of FIG. 3. N can be any suitable number in some embodiments. For example, N can be 500, 1000, 2000, 5000, etc. The N known queries can be selected in any suitable manner in some embodiments. Any suitable N known queries can be selected in some embodiments. For example, in some embodiments, the N known queries can be selected based on a set of queries designated as suitable for training by a person familiar with the machine learning algorithm.

Then, at 408, process 400 can use a natural language processing system to select the M most-similar queries (from the N queries) to query X. Any suitable natural language processing system can be used, such as a natural language processing system instance (e.g., the GENERATIVE PRE-TRAINED TRANSFORMER 3 (GPT3) available from OPENAI of San Francisco, CA) implemented using machine learning server 104 (as described herein). M can be any suitable number in some embodiments, such as 10, 15, 20, 100, etc. The M most-similar queries can be selected in any suitable manner in some embodiments. For example, when using a natural language processing system, the M most-similar queries can be selected by running a semantic search algorithm on the set of questions based on the query. Any suitable semantic search algorithm can be used in some embodiments. For example, in some embodiments, GPT3 can be used to perform a semantic search.

Next, at 410, process 400 can train a machine learning server instance, such a machine learning server instance (e.g., GPT3) in machine learning server 104, using the M most-similar queries along with the corresponding known database-query portions, in some embodiments. In some embodiments, web server 104 can initiate training of machine learning server 104.

Then, at 412, process 400 can end.

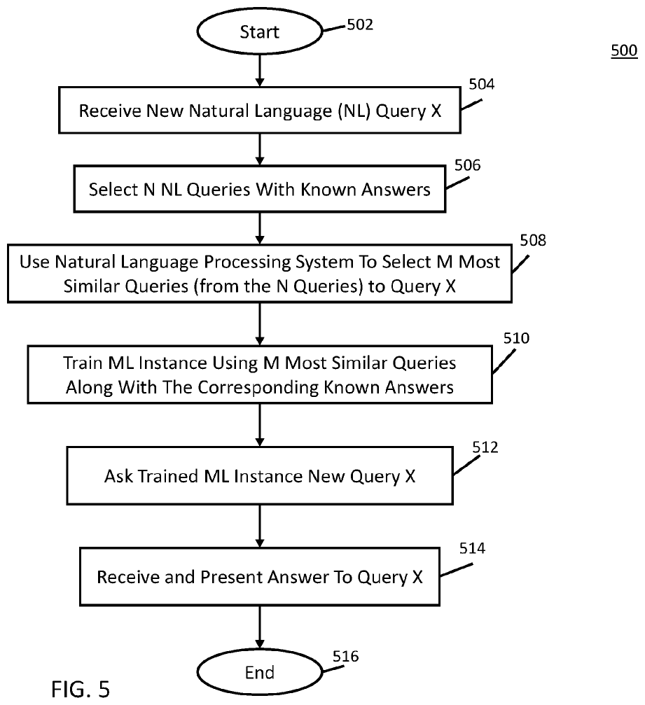

Turning to FIG. 5, another example of a process 500 for training a machine learning algorithm to answer a natural language query in accordance with some embodiments is shown. In some embodiments, the machine learning algorithm can run on any suitable machine learning server, such as machine learning server 104 of FIG. 1.

As illustrated, after process 500 begins at 502, the process receives a natural language (NL) query X at 504. In some embodiments, query X can be received at a user device 106.

Next, at 506, process 500 can select N known NL queries with corresponding known answers (which can be any suitable responses to the N known NL queries, such as actual answers, structured queries that can be used to access the actual answers, commands that can be used to access the actual answers, or any other data or instructions that provide the actual answers or can be used to access the actual answers. N can be any suitable number in some embodiments. For example, N can be 500, 1000, 2000, 5000, etc. The N known queries can be selected in any suitable manner in some embodiments. Any suitable N known queries can be selected in some embodiments. For example, in some embodiments, the N known queries can be selected based on a set of queries designated as suitable for training by a person familiar with the machine learning algorithm.

Then, at 508, process 500 can use a natural language processing system to select the M most-similar queries (from the N queries) to query X. Any suitable natural language processing system can be used, such as a natural language processing system instance (e.g., GPT3) implemented using machine learning server 104 (as described herein). M can be any suitable number in some embodiments, such as 10, 15, 20, 100, etc. The M most-similar queries can be selected in any suitable manner in some embodiments. For example, when using a natural language processing system, the M most-similar queries can be selected by running a semantic search algorithm on the set of questions based on the query. Any suitable semantic search algorithm can be used in some embodiments. For example, in some embodiments, GPT3 can be used to perform a semantic search.

Next, at 510, process 500 can train a machine learning server instance, such a machine learning server instance (e.g., GPT3) in machine learning server 104, using the M most-similar queries along with the corresponding known database-query portions, can be used in some embodiments. In some embodiments, web server 104 can initiate training of machine learning server 104.

Once the ML instance is trained, at 512, process 500 can ask the trained ML instance query X. Process 500 can then receive and present the answer to query X at 514, and end at 516.

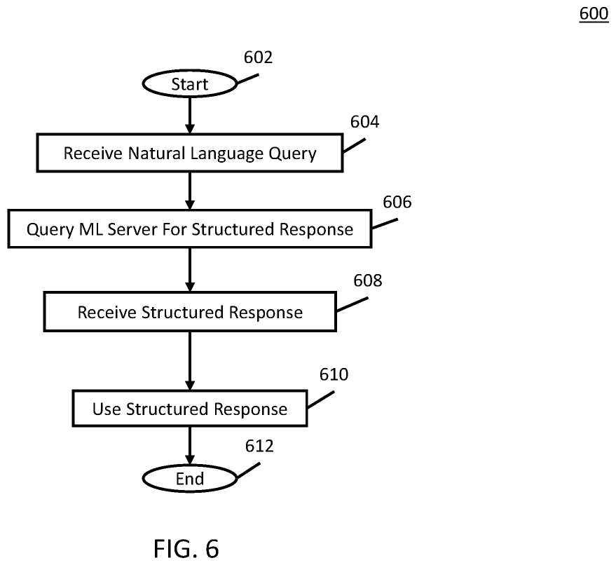

Turning to FIG. 6, an example 600 of a process for receiving a structured response in accordance with some embodiments is illustrated.

As shown, after process 600 begins at 602, the process can receive a natural language query at user device 106 at 604 in some embodiments. Any suitable natural language query can be received in some embodiments.

Next, at 606, process 600 can query a machine learning server for a structured response using the natural language query. Any suitable machine learner server can be used in some embodiments. For example, a natural language processing system can be used, such as a natural language processing system instance (e.g., GPT3) implemented using machine learning server 104 (as described herein). In some embodiments, the machine learning server can be trained using any suitable training queries and corresponding structured responses. For example, the training queries can be any suitable natural language queries and the corresponding structured responses can be corresponding responses in any suitable data structure. More particularly, for example, the structured responses can be SQL queries (or a portion thereof), NoSQL queries (or a portion thereof), Uniform Resource Locators (URLs) (or a portion thereof), JSON files, XML files, and/or any other suitable data structure(s). The structured responses can specify any suitable one or more named entities in some embodiments. As used herein, a named entity is a real-world object, such as a person, an organization, a location, a product, etc., that can be identified by a proper name.

Then, at 608, process 600 can receive the structured response to the natural language query. Any suitable structured response can be received and the structured response can be received in any suitable manner. For example, the structured response can be a SQL query (or a portion thereof), a NoSQL query (or a portion thereof), a Uniform Resource Locator (URL) (or a portion thereof), a JSON file, an XML file, and/or any other suitable data structure(s). The response can specify any suitable one or more entities in some embodiments.

At 610, process 600 can use the structured response in any suitable manner. For example, if the structured response is a URL (or a portion thereof), the process can make an HTTP Get request using the URL (or the portion thereof). As another example, if the structured response is an SQL query (or a portion thereof), the process can make an SQL query using the SQL query (or the portion thereof). As yet another example, if the structured response is a JSON file or an XML file, the process can use the JSON file or XML file to make an application programming interface (API) call.

Finally, process 600 can end at 612.

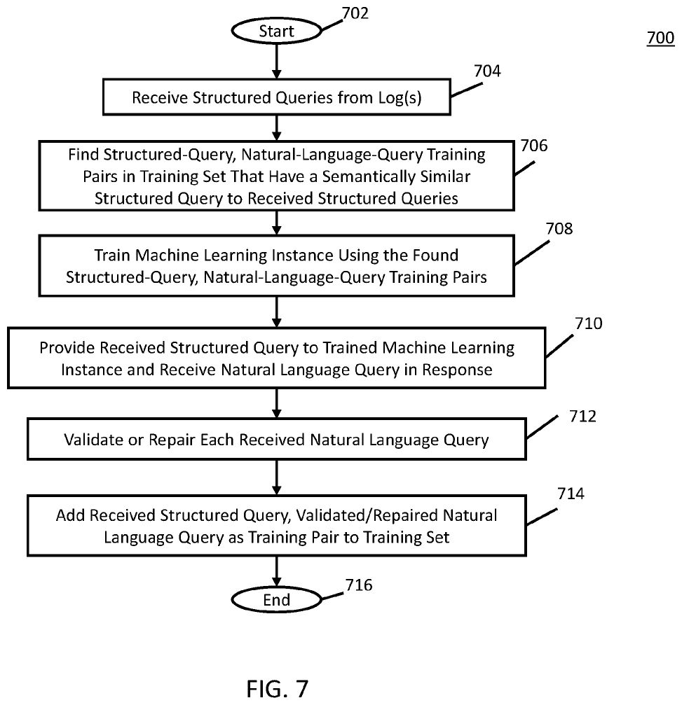

Turning to FIG. 7, an example 700 of a process for generating training samples for training a machine learning instance in accordance with some embodiments is shown. The machine learning instance can be any suitable machine learning instance, such as an instance of GPT3, in some embodiments.

After beginning at 702, at 704, process 700 can receive one or more structured queries from one or more logs of a structured query system. Any suitable one or more structured queries can be used in some embodiments. Any suitable one or more logs of any suitable structured query system can be used in some embodiments.

Next, at 706, process 700 can find structured-query, natural-language-query training pairs in one or more training sets that have a semantically similar structured query to the one or more structured queries received at 704. Any suitable training pairs, and any suitable number of such training pairs, can be found, and the training pairs can be found in any suitable training set(s), in some embodiments. Semantically similar structured queries to the received structured queries can be identified in any suitable manner. For example, in some embodiments, semantically similar structured queries can be identified using a machine learning classifier that has been trained to classify pairs of structured queries as being similar or not similar to classify each combination of: each received structured query; and each structured query of each possible training pair. As another example, in some embodiments, semantically similar structured queries can be identified using a semantic search.

Then, at 708, process 700 can train a machine learning instance (e.g., an instance of GPT3 or any other suitable machine learning instance, in some embodiments) using the training pairs found at 706. The machine learning instance can be trained in any suitable manner in some embodiments.

At 710, process 700 can provide the one or more structured queries received at 704 to the machine learning instance trained at 710 and receive in response a natural language query for each structured query provided. The structure queries can be provided to the machine learning instance, and the natural language query can be received, in any suitable manner.

Next, at 712, process 700 can validate and/or repair each received natural language query. This validation and/or repair can be performed in any suitable manner. For example, in some embodiments, each received natural language query and its corresponding structured query can be presented to a user and process 700 can receive an indication that the natural language query is a valid representation of the structured query, can receive a correction to the natural language query so that it better corresponds to the structured query, or can receive an indication that the naturally language query is invalid.

Then, at 714, process 700 can add each validated or repaired natural language query along its corresponding structured query as a training pair to any suitable training set (including the training set used at 706). Each validated or repaired natural language query along its corresponding structured query can be added as a training pair in any suitable manner.

Finally, process 700 can end at 716.

Process 700 can be performed any suitable number of times, and can process any suitable number of receive structured queries at 704 each time process 700 is performed, in some embodiments.

It should be understood that at least some of the above-described blocks of the process of FIGS. 3, 4, 5, 6, and 7 can be executed or performed in any order or sequence not limited to the order and sequence shown in and described in the figure. Also, some of the above blocks of the process of FIGS. 3, 4, 5, 6, and 7 can be executed or performed substantially simultaneously where appropriate or in parallel to reduce latency and processing times. Additionally or alternatively, some of the above described blocks of the process of FIGS. 3, 4, 5, 6, and 7 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

### Appendix A

Below is an example of HTML code for a web site that can be used to implement process 300 of FIG. 3 in accordance with some embodiments:

```
<!DOCTYPE html>
<html lang=“en”>
<head>
  <meta charset=“UTF-8”>
  <title>Dropdown</title>
</head>
<body>
<select name= colours method=“GET” action=“/”>
  {% for colour in colours %}
  <option value= “{{colours}}” SELECTED>{{colours}}</option>”
  {% endfor %}
</select>
</select>
</body>
</html>
```

### Appendix B

Below is an example of Python code for a web site that can be used to implement process 300 of FIG. 3 in accordance with some embodiments:

```
from flask import Flask
from flask import render_template, url_for, request, redirect
import openai
openai.api_key = “[redacted]”
from prettytable import from_db_cursor
import logging
from MySQLdb import_mysql
import MySQLdb
import json
from gpt import *
from gpt import GPT
from gpt import Example
from setup import setupgpt
import pandas as pd
app = Flask(_name_)
logging.basicConfig(filename=‘multi.log’, level=logging.DEBUG)
def process_input(query, category, querytype):
  from gpt import GPT
  from gpt import Example
  #from setup import setupgpt
  header_list = pd.read_csv(“sqlheaaders.csv”)
  records_class = {‘Tests':‘1’, ‘ODIs': ‘2’, ‘T20is':‘3’}
  gpt = GPT(engine=“davinci”,
    temperature=0.1,
    max_tokens=160)
# gpt.add_example(Example(example1text, example1))
  field_list = header_list.loc[header_list.Tag==querytype].Print.values[0]
  queryset = pd.read_csv(“./Training_Examples.csv”)
  for index, row in queryset.iterrows( ):
    if(row[‘Tag’]==querytype):
      gpt.add_example(Example(row[‘Question’],row[‘SQL’]))
      print(row[‘Question’])
  db=MySQLdb.connect(host=“127.0.0.1”,user=“ciread”,
        passwd=“”,db=“engine”)
  prompt = query
  file1 = open(“queries.log”, “a”) # append mode
  file1.write(“The query is: “+prompt+”\n”)
  file1.close( )
  print(“The query is: “+prompt)
  output = gpt.submit_request(prompt)
  print(“GPT response: “+output.choices[0].text)
  c=db.cursor( )
  dbquerystring = header_list.loc[header_list.Tag==querytype].Header.values[0]+ “
AND xc.records_class_id = “+records_class[category] +
output.choices[0].text.replace(“output: “,” ”)
  print(“DB query:\n”+dbquerystring)
  file1 = open(“queries.log”, “a”) # append mode
  file1.write(“GPT response: “+output.choices[0].text+”\n”)
  file1.close( )
  c.execute(dbquerystring)
#db.query(dismissal_header+output.choices[0].text.replace(“output: A:”,“”)+“\n LIMIT
5”)
    #r=db.store_result( )
    #results = r.fetch_row(maxrows=0, how=2)
  return “<br>This is the query:<h4>“+query +”</h4><br> Results for “+category+” <br
clear=all>”+from_db_cursor(c).get_html_string(fields = field_list.split(“, ”)) #[“Mat”,
“Runs”, “HS”, “Batt Ave”, “100s”, “50s”, “Wkts”, “Bowl Ave”, “bbi”, “bbm”, “5Ws”,
“caught”, “stumped”])
@app.route(‘/’)
def my_form( ):
  return render_template(“multidemo.html”)
@app.route(‘/’, methods=[‘GET’, ‘POST’])
def process_form( ):
  querytype = request.form[‘submit’]
  category = request.form[‘category’]
  print(category)
  if(querytype == “Individual”):
      return process_input(request.form[‘text1’], category, “Batting”) + ‘<br> <a
href=“./”>Try again</a>’
  elif(querytype == “Records”):
    return process_input(request.form[‘text2’], category, “Batting Records”) + ‘<br> <a
href=“./”>Try again</a>’
  else:
    return request.form
if_name_ == ‘_main_’:
  app.run(host=“0.0.0.0”)
```

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for training a machine learning server instance, comprising:
receiving a structured query from a log;
finding structured-query, natural-language-query training pairs that have a semantically similar structured query to the received structured query in a training set;
training a machine learning instance using the structured-query, natural-language-query training pairs;
providing the received structured query to the machine learning instance after being trained;
in response to providing the received structured query to the machine learning instance, receiving a natural language query from the machine learning instance;
validating the received natural language query; and
adding the received structured query and the validated natural language query as a training pair to the training set.

2. The method of claim 1, wherein the machine learning instance is an instance of GENERATIVE PRE-TRAINED TRANSFORMER 3 (GPT3).

3. The method of claim 1, wherein finding structured-query, natural-language-query training pairs that have a semantically similar structured query to the received structured query can be performed using a machine learning classifier that has been trained to classify pairs of structured queries as being similar or not similar to classify each combination of: each received structured query; and each structured query of each possible training pair.

4. The method of claim 1, wherein finding structured-query, natural-language-query training pairs that have a semantically similar structured query to the received structured query can be performed based on a semantic search.

5. A system for training a machine learning server instance, comprising:
a memory; and
at least one hardware processor that is coupled to the memory and that is collectively configured to:
receive a structured query from a log;
find structured-query, natural-language-query training pairs that have a semantically similar structured query to the received structured query in a training set;
train a machine learning instance using the structured-query, natural-language-query training pairs;
provide the received structured query to the machine learning instance after being trained;
in response to providing the received structured query to the machine learning instance, receive a natural language query from the machine learning instance;
validate the received natural language query; and
add the received structured query and the validated natural language query as a training pair to the training set.

6. The system of claim 5, wherein the machine learning instance is an instance of GENERATIVE PRE-TRAINED TRANSFORMER 3 (GPT3).

7. The system of claim 5, wherein finding structured-query, natural-language-query training pairs that have a semantically similar structured query to the received structured query can be performed using a machine learning classifier that has been trained to classify pairs of structured queries as being similar or not similar to classify each combination of: each received structured query; and each structured query of each possible training pair.

8. The system of claim 5, wherein finding structured-query, natural-language-query training pairs that have a semantically similar structured query to the received structured query can be performed based on a semantic search.

9. A non-transitory computer-readable medium containing computer executable instructions that, when executed by a processor, cause the processor to perform a method for training a machine learning server instance, the method comprising:
receiving a structured query from a log;
finding structured-query, natural-language-query training pairs that have a semantically similar structured query to the received structured query in a training set;
training a machine learning instance using the structured-query, natural-language-query training pairs;
providing the received structured query to the machine learning instance after being trained;
in response to providing the received structured query to the machine learning instance, receiving a natural language query from the machine learning instance;
validating the received natural language query; and
adding the received structured query and the validated natural language query as a training pair to the training set.

10. The non-transitory computer-readable medium of claim 9, wherein the machine learning instance is an instance of GENERATIVE PRE-TRAINED TRANSFORMER 3 (GPT3).

11. The non-transitory computer-readable medium of claim 9, wherein finding structured-query, natural-language-query training pairs that have a semantically similar structured query to the received structured query can be performed using a machine learning classifier that has been trained to classify pairs of structured queries as being similar or not similar to classify each combination of: each received structured query; and each structured query of each possible training pair.

12. The non-transitory computer-readable medium of claim 9, wherein finding structured-query, natural-language-query training pairs that have a semantically similar structured query to the received structured query can be performed based on a semantic search.
